(19) United States
(12) Patent Application Publication
(10) Pub. No.: US 2012/0008609 A1
(43) Pub. Date: Jan. 12, 2012

(54) METHOD AND COMMUNICATION DEVICE FOR FEEDING BACK AND RECEIVING PRE-CODING CONTROL INDICATION INFORMATION

(76) Inventors: Xueli MA, Shanghai (CN); Chongyang Han, Shanghai (CN); Jing Li, Shenzhen (CN); Zongjie Wang, Shanghai (CN); Bo Yang, Shanghai (CN)

(21) Appl. No.: 13/237,103

(22) Filed: Sep. 20, 2011

Related U.S. Application Data
(63) Continuation of application No. PCT/CN2009/070926, filed on Mar. 20, 2009.

(51) Int. Cl. H04W 92/00

(52) U.S. Cl. 370/338

(57) ABSTRACT

The present invention relates to the field of wireless network communications, and provides a method and a device for receiving and sending Pre-coding Control Indication (PCI) information in uplink Multiple-Input Multiple Output (MIMO) transmission or uplink Closed Loop Transmit Diversity (CLTD) transmission, so as to solve a problem that the uplink MIMO communication from a terminal to a Base Station (BS) is unable to be realized in the prior art. A BS transmitting method includes carrying a code sequence, which represents PCI information, in a feedback channel of a BS. The beneficial effect of the present invention is: by feeding back the PCI information, the terminal realizes the maximization of a block length supported by an existing channel condition after the uplink MIMO is introduced, so as to improve an uplink transmission rate.

### CROSS-REFERENCE TO RELATED APPLICATIONS

This application is a continuation of International Application No. PCT/CN2009/070926, filed on Mar. 20, 2009, which is hereby incorporated by reference in its entirety.

### FIELD OF THE INVENTION

The present invention relates to the field of wireless network communications, and in particular, to a method and communication device for feeding back and receiving Pre-coding Control Indication (PCI) information.

### BACKGROUND OF THE INVENTION

With the rapid development of the communications technologies, Wideband Code Division Multiple Access (WCDMA), as one of the mainstream technologies in the third mobile communication system, is widely developed and applied all over the world. In the prior art, a Base Station (BS) uses PCI information fed back by a User Equipment (UE) to perform downlink Multiple-Input Multiple-Output (MIMO). A process of the downlink MIMO is briefly described as follows.

The BS generates weighting factors w1, w2, w3, and w4 according to the PCI information fed back by the UE. Specifically, W2 is mapped according to the received PCI, then w4=−w2, and

$$w 1 = w 3 = \frac{1}{\sqrt{2}}$$

are obtained, where (w1, w2) is referred to as a primary pre-coding vector, and (w3, w4) is referred to as a secondary pre-coding vector.

1. A primary transmission block is weighted by using the primary pre-coding vector, and then sent on two antennas, where w1 is a weighting factor of the primary transmission block on an antenna 1, and W2 is a weighting factor of the primary transmission block on an antenna 2.

2. A secondary transmission block is weighted by using the secondary pre-coding vector, and then sent on two antennas, where w3 is a weighting factor of the secondary transmission block on the antenna 1, and W4 is a weighting factor of the secondary transmission block on the antenna 2.

At present, uplink direction in the WCDMA system has a single antenna. In order to further improve uplink transmission rate of the WCDMA system and decrease data transmission delay, the uplink direction also needs to carry data by using a multi-antenna technology, so as to achieve uplink MIMO. In addition, the WCDMA system may also use an uplink Closed Loop Transmit Diversity (CLTD) mode for transmission. Therefore, inventors of the present invention are fully aware that a method for a base station to feed back PCI information needs to be designed, so that a terminal can perform the uplink MIMO transmission or the CLTD transmission according to the PCI information fed back by the BS.

### SUMMARY OF THE INVENTION

Embodiments of the present invention provide a method and device for sending and receiving PCI information.

An embodiment of the present invention provides a method for feeding back PCI information, and the method includes: carrying a code sequence, which represents PCI information, in a feedback channel when a BS performs uplink MIMO transmission or uplink CLTD, where a frame format of the feedback channel is the same as that of a 2 ms Enhanced Dedicated Channel (E-DCH) Hybrid ARQ Indicator Channel (EHICH) or a 2 ms E-DCH Relative Grant Channel (ERGCH), or the same as that of a Fractional Dedicated Physical Channel (F-DPCH).

Another embodiment of the present invention provides a BS, and the BS includes a carrying module, configured to carry a code sequence, which represents PCI information, in a feedback channel of the BS when the BS performs uplink MIMO transmission or uplink CLTD transmission, where a frame format of the feedback channel is the same as that of a 2 ms EHICH or a 2 ms ERGCH, or the same as that of an F-DPCH.

Further another embodiment of the present invention provides a method for receiving PCI information at a terminal side, and the method includes: receiving a code sequence, which represents PCI information, fed back by a BS when the BS performs uplink MIMO transmission or uplink CLTD transmission, where a frame format of a feedback channel used by the BS is the same as that of a 2 ms EHICH or a 2 ms ERGCH, or the same as that of an F-DPCH; and acquiring the PCI information according to the code sequence.

Still further another embodiment of the present invention provides a terminal, and the terminal includes a receiving module, configured to receive a code sequence, which represents PCI information, fed back by a BS when the BS performs uplink MIMO transmission or uplink CLTD transmission, where a frame format of a feedback channel used by the BS is the same as that of a 2 ms EHICH or a 2 ms ERGCH, or the same as that of an F-DPCH; and a mapping module, configured to acquire the PCI information according to the code sequence.

Embodiments of the present invention have the following beneficial effects. In the solutions according to the embodiments of the present invention, the feedback channel, which has the same frame format as that of a 2 ms EHICH or a 2 ms ERGCH or has the same frame format as that of an F-DPCH, is used to carry the PCI information, so that the terminal can implement uplink MIMO transmission or perform uplink CLTD transmission according to the PCI information, thereby maximizing block length supported by existing channel conditions, and improving the uplink transmission rate.

### BRIEF DESCRIPTION OF THE DRAWINGS

The accompanying drawings described herein provide a further understanding of the invention, constitute a part of this application, are not intended to limit the present invention, where

FIG. 1 is a flow chart of a method for feeding back PCI information according to an embodiment of the present invention;

FIG. 2 is a schematic diagram of an orthogonal signature sequence used by a PCI Channel (PCICH) according to an embodiment of the present invention;

FIG. 3 is a schematic diagram of an i^{th} slot index of a PCICH according to an embodiment of the present invention;

FIG. 4 is a structure diagram of a BS for feeding back PCI information according to an embodiment of the present invention;

FIG. 5 is a flow chart of a method for receiving PCI information at a terminal side according to an embodiment of the present invention; and

FIG. 6 is a structure diagram of a terminal according to an embodiment of the present invention.

### DETAILED DESCRIPTION OF THE EMBODIMENTS

In order to make the objectives, technical solutions, and advantages of the present invention more comprehensible, the present invention is further described in detail below through embodiments with the accompanying drawings. Herein, the exemplary embodiments of the present invention and descriptions of the embodiments are only intended to explain the present invention, instead of limiting the present invention.

Embodiments of the present invention provide a method and device for sending and receiving PCI information in uplink MIMO transmission or uplink CLTD transmission. The present invention is described below in detail with reference to the accompanying drawings.

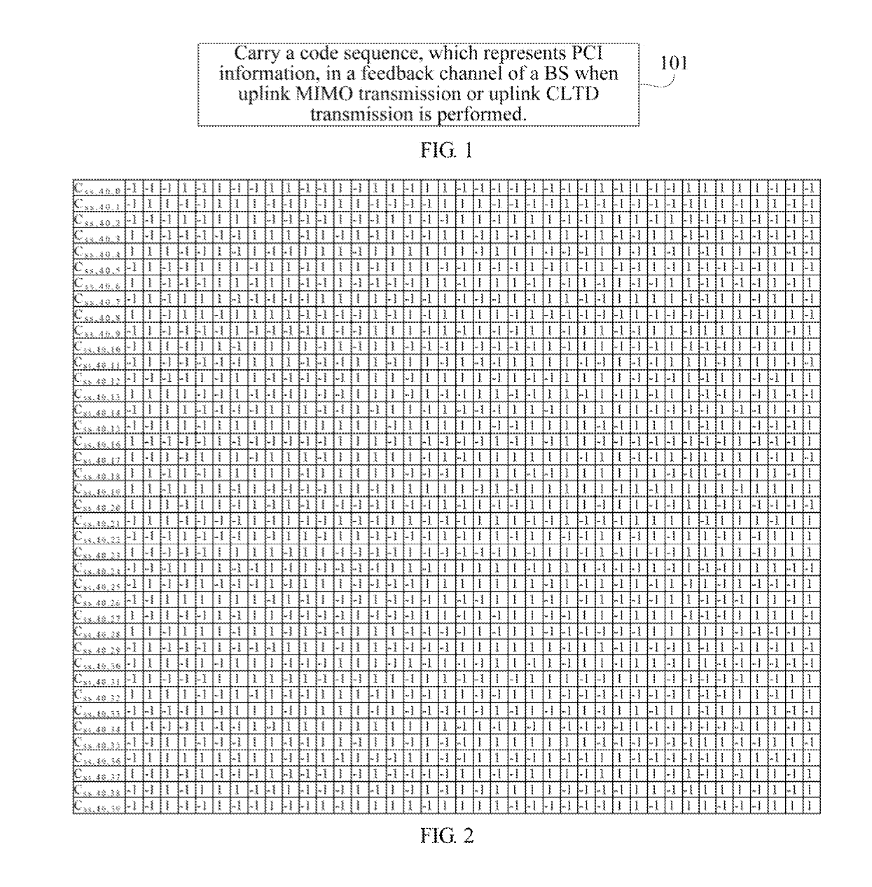

FIG. 1 is a flow chart of a method for feeding back PCI information according to an embodiment of the present invention.

Step 101: A code sequence, which represents PCI information, is carried in a feedback channel of a BS when uplink MIMO transmission or uplink CLTD transmission is performed.

Where PCI is a pre-coding vector fed back to a terminal, so as to enable the terminal to maximize block length supported by existing channel conditions.

As an embodiment of the present invention, the feedback channel may include a Pre-coding Control Indication Channel (PCICH). It can be understood by those skilled in the art that, to facilitate description, PCICH is a name defined for the feedback channel, and is not intended to limit the present invention.

In an embodiment of the present invention, a frame format of the PCICH may be the same as that of a 2 ms Enhanced Dedicated Channel (E-DCH) Hybrid ARQ Indicator Channel (EHICH) or a 2 ms E-DCH Relative Grant Channel (ERGCH), or the same as that of a Fractional Dedicated Physical Channel (F-DPCH).

In another embodiment of the present invention, if the frame format of the PCICH is the same as that of the 2 ms EHICH or 2 ms ERGCH, the first two slots of the PCICH may be used to carry the code sequence.

In further another embodiment of the present invention, if the frame format of the PCICH is the same as that of the 2 ms EHICH or a 2 ms ERGCH, three slots of the PCICH may be used to carry the code sequence.

In still further another embodiment of the present invention, if the frame format of the PCICH is the same as that of the F-DPCH, a single slot of the PCICH may be used to carry the code sequence.

In still further another embodiment of the present invention, if the frame format of the PCICH is the same as that of the F-DPCH, two slots of the PCICH may be used to carry the code sequence.

Descriptions are made through embodiments below.

### Embodiment 1

In this embodiment, a PCICH channel is a physical channel for feeding back PCI information, which has the same frame structure as that of a 2 ms EHICH or ERGCH, and uses a signature (or a channelization code) to distinguish users. Sequences b_{i,0}, b_{i,1}, . . . , b_{i,39} transmitted in a slot i of the PCICH channel are defined by a formula b_{i,j}=aᵢ C_{ss,40, m(i),j}. Herein, the orthogonal signature sequence C_{ss,40, m(i),j} and the index m(i) of the i^{th} slot are determined as follows.

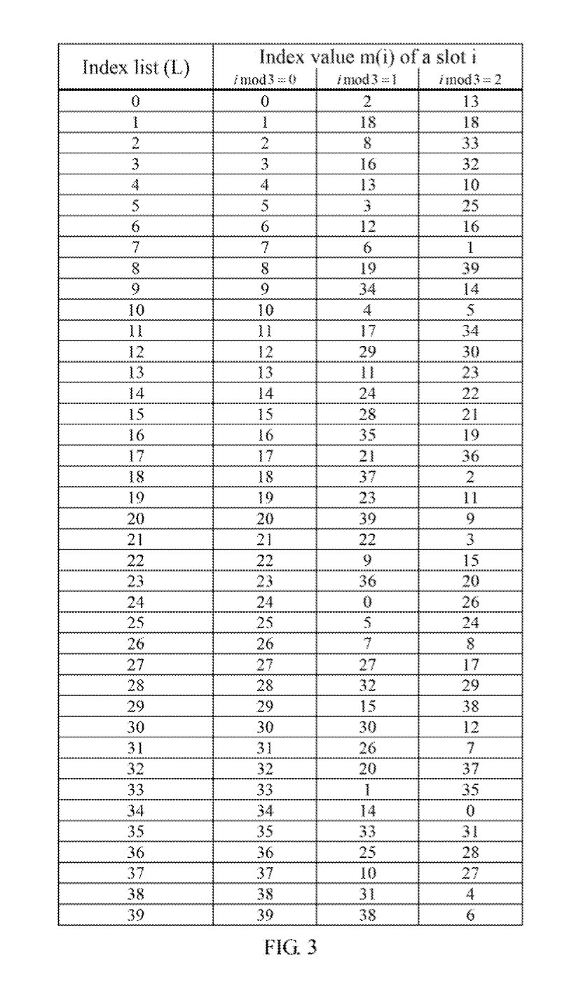

C_{ss,40, m(i)} is as shown in FIG. 2, and the index m(i) of the i^{th} slot is as shown in FIG. 3.

A specific method for selecting the orthogonal signature sequence includes: finding out a corresponding row in an index list (L) as shown in FIG. 3 according to a value of a signature sequence index L configured by an upper layer, then acquiring index m(i) values of different slots in the row according to the value of the slot i, and finding out a corresponding row in FIG. 2 according to the m(i) value, where a signature sequence represented by the row is the signature sequence used in the slot i.

The value of aᵢ may vary in different slots, for example, may be 0, or 1.

Values of three slots of the PCICH channel are corresponding to three aᵢ, a code sequence formed by the three aᵢ represents the PCI information, and a mapping relationship is shown in FIG. 1. The PCICH has only sub-frames of 2 ms, each sub-frame includes three slots and can carry 3-bit PCI information, and the PCI information has four values (with respect to a terminal having two antennas). Therefore, a 3-bit code sequence can be used to represent the four values of the PCI. As for a terminal having more than two antennas, more bits may be used to represent PCI value information. Table 1 shows a mapping relationship between PCIs and code sequences.

TABLE 1
Mapping Relationship Between PCI Values And Code Sequences

| Code Sequence | PCI Value |
|---|---|
| 111 | 0 |
| 100 | 1 |
| 010 | 2 |
| 001 | 3 |

In another embodiment of the present invention, the mapping relationship between the code sequences and the PCI values may be: a PCI value 0 corresponding to a code sequence 000, a PCI value 1 corresponding to a code sequence 011, a PCI value 2 corresponding to a code sequence 101, and a PCI value 3 corresponding to a code sequence 110. Definitely, it can be understood by persons skilled in the art that, the mapping relationships listed above are only exemplary, and other different mapping manners also fall within the protection scope of the present invention.

### Embodiment 2

The method of this embodiment is similar to Embodiment 1, and the difference is that only the first two slots of the PCICH are used to carry the code sequence representing the PCI information, and the third slot is reserved, that is, a 2-bit code sequence is used to represent four values of the PCI. An example of the mapping relationship is shown in Table 2, but other mapping relationships different from that in Table 2 also fall within the protection scope of the present invention.

TABLE 2
Mapping Relationship Between PCI Values And Code Sequences

| Code Sequence | PCI Value |
|---|---|
| 11 | 0 |
| 10 | 1 |
| 01 | 2 |
| 00 | 3 |

### Embodiment 3

In this embodiment, the frame format of the PCICH is the same as that of the F-DPCH.

In this embodiment, each slot of the PCICH carries 2-bit PCI information, and each slot feeds back one complete PCI information. For example, according to the mapping relationship in Table 2, 2-bit information is used to present different PCI values.

### Embodiment 4

In this embodiment, the frame format of the PCICH is the same as that of the F-DPCH. In this embodiment, two PCICH slots carry a code sequence corresponding to one complete PCI information, where the first bit of the code sequence is carried in the first PCICH slot, the second bit of the code sequence is carried in the second PCICH slot, so that the two PCICH slots carry one complete PCI information.

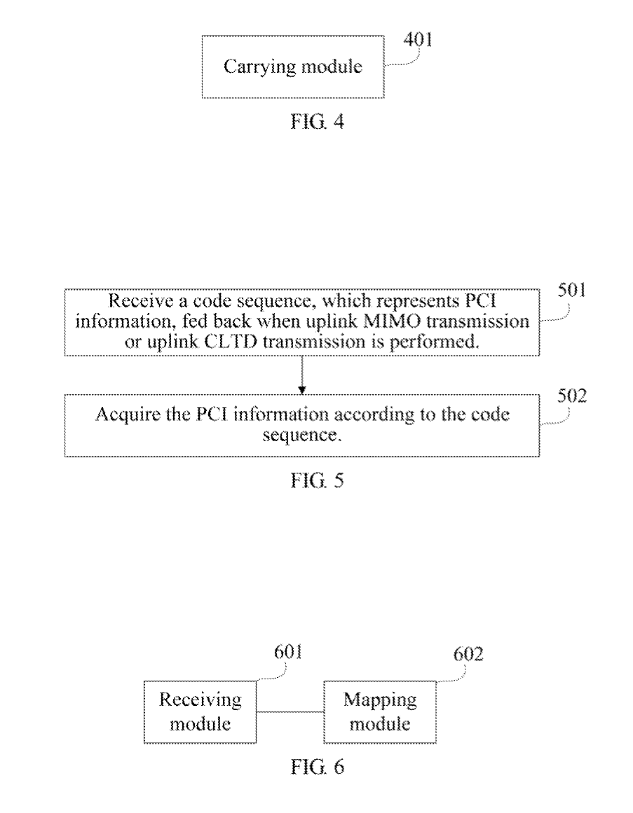

FIG. 4 is a structure diagram of a BS for feeding back PCI information according to an embodiment of the present invention.

The BS includes a carrying module 401 configured to carry a code sequence, which represents PCI information, in a feedback channel of the BS when uplink MIMO transmission or uplink CLTD transmission is performed.

In an embodiment of the present invention, the feedback channel may include a PCICH. It can be understood by those skilled in the art that, to facilitate description, PCICH is a name defined for the feedback channel, and is not intended to limit the present invention.

In another embodiment of the present invention, a frame format of the PCICH may be the same as that of a 2 ms EHICH or a 2 ms ERGCH, or the same as that of an F-DPCH.

In further another embodiment of the present invention, if the frame format of the PCICH is the same as that of the 2 ms EHICH or a 2 ms ERGCH, the carrying module 401 may carry the code sequence in the first two slots of the PCICH.

In still further another embodiment of the present invention, if the frame format of the PCICH is the same as that of the 2 ms EHICH or a 2 ms ERGCH, the carrying module 401 may carry the code sequence in three slots of the PCICH.

In still further another embodiment of the present invention, if the frame format of the PCICH is the same as that of the F-DPCH, the carrying module 401 may carry the code sequence in a single slot of the PCICH.

In still further another embodiment of the present invention, if the frame format of the PCICH is the same as that of the F-DPCH, the carrying module 401 may carry the code sequence in two slots of the PCICH.

The detailed schemes for the carrying module 401 to carry the code sequence, which represents the PCI information, on the PCICH may be obtained with reference to the descriptions of the embodiments of the method for feeding back the PCI information, and is not further described in detail herein again.

FIG. 5 is a flow chart of a method for receiving PCI information at a terminal side according to an embodiment of the present invention.

Step 501: Receive a code sequence, which represents PCI information, fed back when uplink MIMO transmission or uplink CLTD transmission is performed.

Step 502: Acquire the PCI information according to the code sequence.

In an embodiment of the present invention, in step 501, if a frame format of the received PCICH is the same as that of a 2 ms EHICH or a 2 ms ERGCH, the code sequence may be acquired from first two slots of the PCICH; or the code sequence may be acquired from three slots of the PCICH.

In another embodiment of the present invention, in step 501, if the frame format of the received PCICH is the same as that of a F-DPCH, the code sequence may be acquired from a single slot of the PCICH; or one 1-bit PCI information is acquired from each of two slots of the PCICH, and then the two 1-bit PCI information are combined into the code sequence.

It can be understood by those skilled in the art that, to facilitate description, PCICH is a name defined for the feedback channel, and is not intended to limit the present invention.

In another embodiment of the present invention, after step 502, the method may further include acquiring a pre-coding weight w₂^{pref} of a second antenna corresponding to the PCI information through Table 3.

TABLE 3
Mapping Relationship Of PCI Values And Pre-coding Weights

| w₂^{pref} | PCI Value |
|---|---|
| $\frac{1 + j}{2}$ | 0 |
| $\frac{1 - j}{2}$ | 1 |
| $\frac{- 1 + j}{2}$ | 2 |
| $\frac{- 1 - j}{2}$ | 3 |

In Table 3, j is a complex number.

A weighting factor w₁^{pref} of a first antenna is a constant, and the w₁^{pref} and the w₂^{pref} form a primary pre-coding vector (w₁^{pref}, w₂^{pref}). An optional secondary pre-coding vector is a unique determination function of the primary pre-coding vector, so the terminal can achieve the communication in uplink MIMO mode through the primary pre-coding vector and the secondary pre-coding vector.

FIG. 6 is a structure diagram of a terminal according to an embodiment of the present invention.

The terminal includes a receiving module 601 configured to receive a code sequence, which represents PCI information, fed back in uplink MIMO transmission or uplink CLTD transmission; and a mapping module 602, configured to acquire the PCI information according to the code sequence.

In an embodiment of the present invention, if the frame format of the PCICH received by the receiving module 601 is the same as that of a 2 ms EHICH or a 2 ms ERGCH, the mapping module 602 may acquire the code sequence from first two slots of the PCICH or acquire the code sequence from three slots of the PCICH.

In another embodiment of the present invention, if the frame format of the PCICH received by the receiving module 601 is the same as that of a F-DPCH, the mapping module 602 may acquire the code sequence from a single slot of the PCICH, or may acquire one 1-bit PCI information from each of two slots of the PCICH and then combine the two 1-bit PCI information into the code sequence.

In further another embodiment of the present invention, the terminal may further include an MIMO module or an uplink CLTD module. The MIMO module is configured to perform uplink MIMO transmission by using the PCI information; and the uplink CLTD module is configured to perform uplink CLTD transmission by using the PCI information.

In still further another embodiment of the present invention, a table of mapping relationship between PCI values and pre-coding weights is further included. The MIMO module searches the table of mapping relationship between PCI values and pre-coding weights according to the PCI value to obtain a pre-coding weight w₂^{pref} of a second antenna, and achieves the communication in uplink MIMO mode according to (w₁^{pref}, w₂^{pref}).

Persons of ordinary skill in the art should understand that all or a part of the steps of the methods according to the embodiments may be implemented by a program instructing relevant hardware. The program may be stored in a computer readable storage medium. When the program runs, the steps of the methods according to the embodiments are performed. The storage medium includes any medium that is capable of storing program codes, such as a ROM, a RAM, a magnetic disk, and an optical disk.

The beneficial effect of embodiments of the present invention is: by feeding back the PCI information, the terminal can maximize a block length supported by an existing channel condition in uplink MIMO transmission or uplink CLTD transmission, so as to improve an uplink transmission rate.

The method for feeding back and receiving PCI, and the communication device according to the embodiments of the present invention are applicable not only in uplink MIMO transmission, but also in uplink CLTD transmission.

The objectives, technical solutions, and beneficial effects of the present invention have been described in detail through the above specific embodiments. It should be understood that the above descriptions are merely exemplary embodiments of the present invention, but not intended to limit the protection scope of the present invention. Any modification, equivalent replacement, or improvement made without departing from the spirit and principle of the present invention should fall within the scope of the present invention.

1. A method for feeding back Pre-coding Control Indication (PCI) information, comprising:
carrying a code sequence, which represents PCI information, in a feedback channel when a Base Station (BS) performs uplink Multiple-Input Multiple-Output (MIMO) transmission or uplink Closed Loop Transmit Diversity (CLTD) transmission; wherein
a frame format of the feedback channel is the same as that of a 2 ms Enhanced Dedicated Channel (E-DCH) Hybrid ARQ Indicator Channel (EHICH) or a 2 ms E-DCH Relative Grant Channel (ERGCH), or the same as that of a Fractional Dedicated Physical Channel (F-DPCH).

2. The method according to claim 1, wherein if the frame format of the feedback channel is the same as that of the 2 ms EHICH or the 2 ms ERGCH, first two slots of the feedback channel are used to carry the code sequence, or three slots of the feedback channel are used to carry the code sequence.

3. The method according to claim 1, wherein if the frame format of the feedback channel is the same as that of the 2 ms EHICH or the 2 ms ERGCH, a sequence transmitted in i^{th} slot of the feedback channel is b_{i,j}=aᵢC_{ss,40, m(i),j}; wherein
the values of i and j are in the range of 0 to 39, C_{ss,40, m(i),j} is a signature sequence, and the value of aᵢ in each slot i is 0 or 1; and the code sequence is a set of aᵢ.

4. The method according to claim 1, wherein if the frame format of the feedback channel is the same as that of the F-DPCH, a single slot of the feedback channel is used to carry the code sequence, or two slots are respectively used to carry the code sequence.

5. A base station (BS), comprising:
a carrying module, configured to carry a code sequence, which represents Pre-coding Control Indication (PCI) information, in a feedback channel of the BS when uplink Multiple-Input Multiple-Output (MIMO) transmission or uplink Closed Loop Transmit Diversity (CLTD) transmission is performed, wherein a frame format of the feedback channel is the same as that of a 2 ms Enhanced Dedicated Channel (E-DCH) Hybrid ARQ Indicator Channel (EHICH) or a 2 ms E-DCH Relative Grant Channel (ERGCH), or the same as that of a Fractional Dedicated Physical Channel (F-DPCH).

6. The BS according to claim 5, wherein if the frame format of the feedback channel is the same as that of the 2 ms EHICH or the 2 ms ERGCH, the carrying module is further configured to carry the code sequence in first two slots of the feedback channel, or carry the code sequence in three slots of the feedback channel.

7. The BS according to claim 5, wherein if the frame format of the feedback channel is the same as that of the F-DPCH,
the carrying module is further configured to carry the code sequence in a single slot of the feedback channel; or
the carrying module is further configured to respectively carry 1 bit of the code sequence in both of two slots of the feedback channel.

8. A method for receiving Pre-coding Control Indication (PCI) information at a terminal side, comprising:
receiving a code sequence, which represents PCI information, fed back by a Base Station (BS) when performing uplink Multiple-Input Multiple Output (MIMO) transmission or uplink Closed Loop Transmit Diversity (CLTD) transmission, wherein a frame format of the feedback channel used by the BS is the same as that of a 2 ms Enhanced Dedicated Channel (E-DCH) Hybrid ARQ Indicator Channel (EHICH) or a 2 ms E-DCH Relative Grant Channel (ERGCH), or the same as that of a Fractional Dedicated Physical Channel (F-DPCH); and
acquiring the PCI information according to the code sequence.

9. The method according to claim 8, wherein in the receiving the code sequence representing the PCI information, if a frame format of the received feedback channel is the same as that of the 2 ms EHICH or the 2 ms ERGCH,
acquiring the code sequence from first two slots of the feedback channel; or
acquiring the code sequence from three slots of the feedback channel.

10. The method according to claim 8, wherein in the receiving the code sequence representing the PCI information, if a frame format of the received feedback channel is the same as that of the F-DPCH,
acquiring the code sequence from a single slot of the feedback channel; or
acquiring one 1-bit information from each of two slots of the feedback channel, and combining the two 1-bit information into the code sequence.

11. The method according to claim 8, wherein after the acquiring the PCI information according to the code sequence, the method further comprises:
performing uplink MIMO communication by using the PCI information.

12. The method according to claim 11, wherein the performing the uplink MIMO communication by using the PCI information comprises:
acquiring a pre-coding weight w₂^{pref} corresponding to the PCI information through a mapping relationship table of PCI values and pre-coding weights; and
realizing the uplink MIMO communication by using the pre-coding weight.

13. A terminal, comprising:
a receiving module, configured to receive a code sequence, which represents Pre-coding Control Indication (PCI) information, fed back by a Base Station (BS) when performing uplink Multiple-Input Multiple Output (MIMO) transmission or uplink Closed Loop Transmit Diversity (CLTD) transmission, wherein a frame format of the feedback channel used by the BS is the same as that of a 2 ms Enhanced Dedicated Channel (E-DCH) Hybrid ARQ Indicator Channel (EHICH) or a 2 ms E-DCH Relative Grant Channel (ERGCH), or the same as that of a Fractional Dedicated Physical Channel (F-DPCH); and
a mapping module, configured to acquire the PCI information according to the code sequence.

14. The terminal according to claim 13, wherein if the frame format of the feedback channel received by the receiving module is the same as that of the 2 ms EHICH or the 2 ms ERGCH,
the mapping module is further configured to acquire the code sequence from first two slots of the feedback channel; or
the mapping module is further configured to acquire the code sequence from three slots of the feedback channel.

15. The terminal according to claim 13, wherein if the frame format of the feedback channel received by the receiving module is the same as that of the F-DPCH, the mapping module is further configured to acquire the code sequence from a single slot of the feedback channel; or
the mapping module is further configured to acquire one 1-bit PCI information from each two slots of the feedback channel, and then to combine the two 1-bit PCI information into the code sequence.

16. The terminal according to claim 13, further comprising:
an MIMO module, configured to perform uplink MIMO transmission according to the PCI information.

17. The terminal according to claim 16, further comprising a mapping relationship table of PCI values and pre-coding weights, wherein
the MIMO module is further configured to search the mapping relationship table of PCI values and pre-coding weights according to the PCI value, to obtain a pre-coding weight w₂^{pref} of a second antenna, and to achieve the communication in uplink MIMO mode according to (w₁^{pref}, w₂^{pref}).
